(19) United States
(12) Patent Application Publication
(10) Pub. No.: US 2012/0129040 A1
(43) Pub. Date: May 24, 2012

(54) BATTERY ARRAY AND BATTERY PACK HAVING THE SAME

(75) Inventor: Kim-Yul Hwang, Yongin-si (KR)

(73) Assignee: Samsung SDI Co., Ltd., Yongin-si (KR)

(21) Appl. No.: 13/164,658

(22) Filed: Jun. 20, 2011

(30) Foreign Application Priority Data
Nov. 19, 2010 (KR) 10-2010-0115665

(51) Int. Cl. H01M 2/10; B23P 11/00

(52) U.S. Cl. 429/158; 29/428

(57) ABSTRACT

A battery array is disclosed. In one embodiment, the battery array includes a plurality of batteries arranged in N rows and three columns, wherein N is a natural number of 2 or more, wherein three batteries in each row are connected in parallel so as to make one bundle, wherein the batteries are sequentially arranged to form N bundles, and wherein the polarities of electrodes of the batteries, when seen from the same side of the battery array, are alternately arranged from a first bundle in the first row to an N-th bundle in the N-th row. The battery array may further include i) a plurality of connection taps configured to sequentially connect in series the first bundle to the N-th bundle and ii) first and second polarity output terminals provided in the first bundle and the N-th bundle, respectively.

### CROSS-REFERENCE TO RELATED APPLICATION

This application claims priority to and the benefit of Korean Patent Application No. 10-2010-0115665, filed on Nov. 19, 2010, in the Korean Intellectual Property Office, the entire content of which is incorporated herein by reference.

### BACKGROUND

1. Field

The described technology generally relates to a battery array and a battery pack having the same.

2. Description of the Related Technology

As a variety of mobile devices have been widely used in recent years, batteries, such as a primary battery and a secondary battery, are widely used.

Batteries used in industries or middle and heavy electronic apparatuses need high output, such that high-capacity batteries are used or a plurality of standard battery cells are connected to increase the output.

### SUMMARY

One inventive aspect is a battery array having both electrode output terminals at the minimum distance from each other even having a plurality of batteries arranged in parallel or in series, and a battery pack including the battery array.

Another aspect is a battery array which has an NS3P type with N rows and three columns (N is a natural number of 2 or more) includes batteries, connection taps, and output terminals.

A plurality of batteries are provided. Three batteries connected in parallel make one bundle and are sequentially disposed such that the polarities of the first bundle to the N-th bundles are alternately shown, with respect to one side with electrodes. The connection taps connect the batteries in the bundles, respectively, and sequentially connect the first bundle to the N-th bundle in series. First and second polarity output terminals are provided to the first bundle to the N-th bundle, respectively.

Further, the batteries may be disposed under a first rule prescribing that at least one battery of each of the first bundle to the N-th bundle should be disposed in the outermost row or column, with respect to one side with the electrodes, a second rule prescribing that the n-th bundle (n is a natural value between 2 and N) should be disposed adjacent to the n−1-th bundle in the outermost row or column and the first bundle and the N-th bundle are should be disposed adjacent to each other in the outermost row or column, and a third rule prescribing that the polarities of the n−1-th bundle and the n-th bundle should be different.

Further, the first and second polarity output terminals may extend from the connection taps of the adjacent batteries, respectively.

Further, the first and second polarity output terminals may be simultaneously provided one of one side with the electrodes and the other side, when the N is an even number.

Further, one first polarity output terminal and one second polarity output terminal may be formed at one side with the electrodes and the other side, respectively, when the N is an odd number. Further, the battery array may further include an extension tap that extends from the first polarity output terminal to the outer circumference of the battery with the second polarity output terminal. Further, the battery array may further include an extension tap that extends from the second polarity output terminal to the outer circumference of the battery with the first polarity output terminal.

The battery may have a cylindrical shape and the connection tap may be made of nickel or a nickel alloy.

Another aspect is a battery pack having a battery array that has an NS3P type with N rows and three columns (N is a natural number of 2 or more), wherein the battery pack includes batteries, connection taps, a first polarity output terminal, a second polarity output terminal, a protection circuit module, and a case.

A plurality of batteries are provided and three batteries connected in parallel make one bundle and are sequentially disposed such that the polarities of the first bundle to the N-th bundles are alternately shown, with respect to one side with electrodes. The connection taps connect the batteries in the bundles, respectively, and sequentially connect the first bundle to the N-th bundle in series. First and second polarity output terminals are provided to the first bundle to the N-th bundle, respectively. The protection circuit module is connected with the output terminals. The case accommodates and supports the battery array, the connection taps, the output terminals, and the protection circuit module.

Further, the batteries may be disposed under a first rule prescribing that at least one battery of each of the first bundle to the N-th bundle should be disposed in the outermost row or column, with respect to one side with the electrodes, a second rule prescribing that the n-th bundle (n is a natural value between 2 and N) should be disposed adjacent to the n−1-th bundle in the outermost row or column and the first bundle and the N-th bundle are should be disposed adjacent to each other in the outermost row or column, and a third rule prescribing that the polarities of the n−1-th bundle and the n-th bundle should be different.

Further, the first and second polarity output terminals may extend from the connection taps of the adjacent batteries, respectively.

Further, the first and second polarity output terminals may be simultaneously provided one of one side with the electrodes and the other side, when the N is an even number.

Further, one first polarity output terminal and one second polarity output terminal may be formed at one side with the electrodes and the other side, respectively, when the N is an odd number. Further, the battery array may further include an extension tap that extends from the first polarity output terminal to the outer circumference of the battery with the second polarity output terminal. Further, the battery array may further include an extension tap that extends from the second polarity output terminal to the outer circumference of the battery with the first polarity output terminal.

Further, the battery may have a cylindrical shape.

Further, the connection tap may be made of nickel or a nickel alloy.

Another aspect is a battery array, comprising: a plurality of batteries arranged in N rows and three columns, wherein N is a natural number of 2 or more, wherein three batteries in each row are connected in parallel so as to make one bundle, wherein the batteries are sequentially arranged to form N bundles, and wherein the polarities of electrodes of the batteries, when seen from the same side of the battery array, are alternately arranged from a first bundle in the first row to an N-th bundle in the N-th row; a plurality of connection taps configured to sequentially connect in series the first bundle to the N-th bundle; and first and second polarity output terminals provided in the first bundle and the N-th bundle, respectively.

In the above battery array, the arrangement of the batteries satisfies first, second and third rules, wherein the first rule prescribes that at least one battery of each of the first bundle to the N-th bundle is disposed in the outermost row or column, wherein the second rule prescribes that i) the n-th bundle (n is a natural value between 2 and N) is disposed adjacent to the (n−1)-th bundle in the outermost row or column and ii) the first bundle and the N-th bundle are disposed adjacent to each other in the outermost row or column, and wherein the third rule prescribes that the polarities of the n−1-th bundle and the n-th bundle are different.

In the above battery array, the first and second polarity output terminals extend from the connection taps provided in the first bundle and N-th bundle, respectively. In the above battery array, the first and second polarity output terminals are provided on both sides of the electrodes of the batteries, where N is an even number. In the above battery array, the first polarity output terminal is formed in a first side of the battery array, and wherein the second polarity output terminal is formed in a second side of the battery array, which is opposing the first side, where N is an odd number.

The above battery array further comprises an extension tap that extends from the first polarity output terminal along an outer circumference of the battery on which the second polarity output terminal is formed. The above battery array further comprises an extension tap that extends from the second polarity output terminal to along an outer circumference of the battery on which the first polarity output terminal is formed. In the above battery array, the battery has a cylindrical shape. In the above battery array, the connection tap is made of nickel or a nickel alloy.

Another aspect is a battery pack having a battery array, the battery pack comprising: a plurality of batteries arranged in N rows and three columns, wherein N is a natural number of 2 or more, wherein three batteries in each row are connected in parallel so as to make one bundle, wherein the batteries are sequentially arranged to form N bundles, and wherein the polarities of electrodes of the batteries, when seen from the same side of the battery array, are alternately arranged from a first bundle in the first row to an N-th bundle in the N-th row; a plurality of connection taps configured to sequentially connect in series the first bundle to the N-th bundle; first and second polarity output terminals provided in the first bundle and the N-th bundle, respectively; a protection module to which the output terminals are connected; and a case accommodating the batteries, the connection taps, the output terminals and the protection module.

In the above battery array, the arrangement of the batteries satisfies first, second and third rules, wherein the first rule prescribes that at least one battery of each of the first bundle to the N-th bundle is disposed in the outermost row or column, wherein the second rule prescribes that i) the n-th bundle (n is a natural value between 2 and N) is disposed adjacent to the n−1-th bundle in the outermost row or column and ii) the first bundle and the N-th bundle are disposed adjacent to each other in the outermost row or column, and wherein the third rule prescribes that the polarities of the (n−1)-th bundle and the n-th bundle are different.

In the above battery array, the first and second polarity output terminals extend from the connection taps provided in the first bundle and N-th bundle, respectively. In the above battery array, first and second polarity output terminals are provided on both sides of the electrodes of the batteries, where N is an even number. In the above battery array, the first polarity output terminal is formed in a first side of the battery array, and wherein the second polarity output terminal is formed in a second side of the battery array, which is opposing the first side, where N is an odd number.

The above battery array further comprises an extension tap that extends from the first polarity output terminal along an outer circumference of the battery on which the second polarity output terminal is formed. The above battery array further comprises an extension tap that extends from the second polarity output terminal along an outer circumference of the battery on which the first polarity output terminal is formed. In the above battery array, the battery has a cylindrical shape. In the above battery array, the connection tap is made of nickel or a nickel alloy.

Another aspect is a method of making a battery array, the method comprising: providing a plurality of batteries arranged in N rows and three columns, wherein N is a natural number of 2 or more, wherein three batteries in each row are connected in parallel so as to make one bundle, wherein the batteries are sequentially arranged to form N bundles, and wherein the polarities of electrodes of the batteries, when seen from the same side of the battery array, are alternately arranged from a first bundle in the first row to an N-th bundle in the N-th row; arranging the first bundle to the N-th bundle such that at least one battery is positioned in the outermost column or row; placing an n-th bundle adjacent to an (n−1))-th bundle in the outermost column or row, wherein n is a natural number between 2 and N; disposing the first bundle adjacent to the N-th bundle in the outermost column or row; and arranging the polarities of the n−1-th bundle and the n-th bundle to be different.

The above method further comprises: sequentially connecting in series the first bundle to the N-th bundle via a plurality of connection taps; and providing first and second polarity output terminals in the first bundle and the N-th bundle, respectively.

### BRIEF DESCRIPTION OF THE DRAWINGS

FIG. 1A is a perspective view showing a multi-battery array in a common multi-parallel/series array.

FIG. 1B is a perspective view showing the other side of the battery array of FIG. 1A.

FIG. 2A is a perspective view showing when the batteries of the battery array of FIG. 1A are connected via connection taps.

FIG. 2B is a perspective view showing the other side of the battery array of FIG. 2A.

FIG. 3A is a conceptual diagram illustrating positions of batteries at each side of the battery array.

FIG. 3B is a conceptual diagram of the battery array projected from one side.

FIG. 4A is a conceptual diagram showing one side of a 7S3P type battery array according to one embodiment.

FIG. 4B is a conceptual diagram showing the other side of the battery array of FIG. 4A.

FIG. 4C is a conceptual diagram of the battery array of FIG. 4A, projected from one side.

FIG. 5 is a perspective view showing the battery array of FIG. 4C.

FIGS. 6A to 6D are conceptual diagrams showing multiple battery arrays according to various embodiments.

FIG. 7 is an exploded perspective view showing an embodiment of a battery pack having battery array.

### DETAILED DESCRIPTION

Embodiments will be described with reference to the accompanying drawings. As those skilled in the art would realize, the described embodiments may be modified in various different ways. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

The terms representing directions, such as “up, down, left, right” used herein are considered to be based on the status shown in the drawings, if not specifically defined or stated. Further, the same reference numerals represent the same parts throughout the embodiments.

When required voltage is higher than the voltage of a single battery, a plurality of batteries are connected in series to satisfy this case. Meanwhile, when required capacity is larger than the capacity of a single battery, a plurality of batteries are connected in parallel to satisfy this case. On the other hand, a plurality of batteries are connected and used in parallel or in series in order to achieve predetermined voltage and capacity. A plurality of batteries connected in series or in parallel are referred to as a battery array herein.

Further, y batteries connected in parallel are referred to as one bundle hereafter. Further, a structure of x bundles connected in series is expressed as xSyP (x Series y Parallel).

Meanwhile, arrangement and connection of the batteries can be simply expressed as the following steps.

First step: Distinguish bundles in accordance with the number of batteries that are connected in parallel.

Second step: Dispose the bundles in accordance with the connection order.

Third step: Connect the batteries in each bundle and connect the bundles in series.

However, the third step is conceptually provided to help understanding connection of the batteries, which does not imply that the bundles should be electrically connected or connected by specific members.

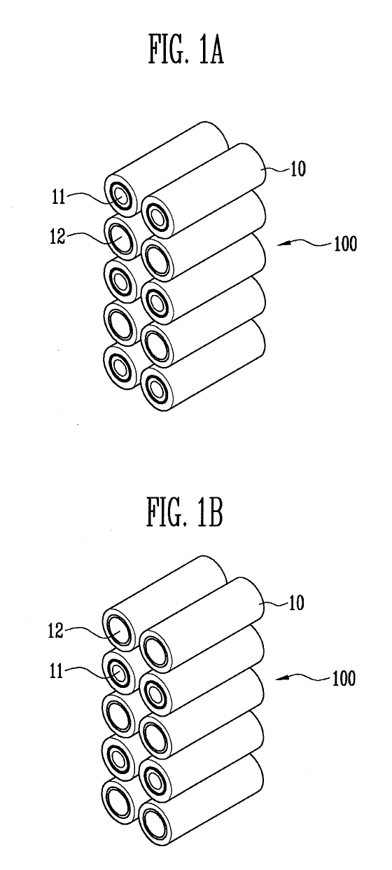

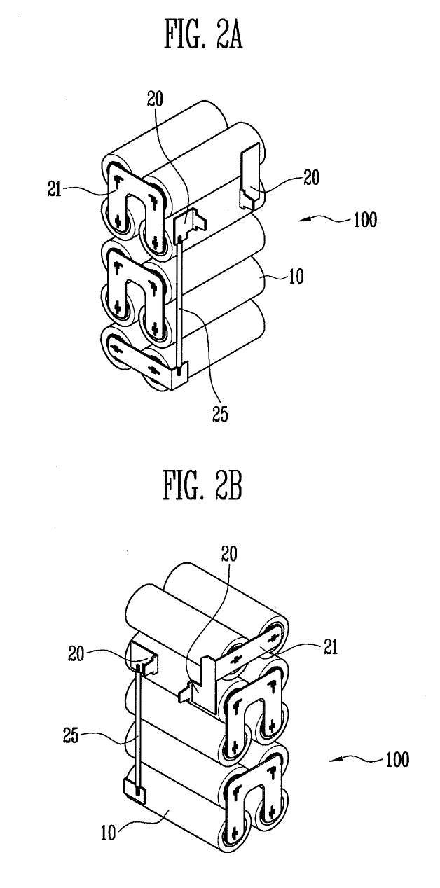

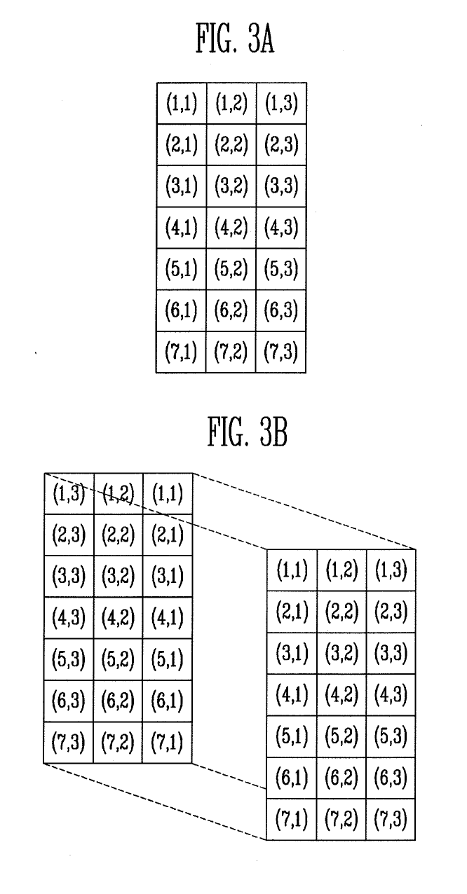

The connection configuration of a common 5S2P battery array is described hereafter in accordance with the steps. FIGS. 1A to 2B show an example of a 5S2P battery array 100. FIG. 1B is a perspective view showing the other side of FIG. 1A.

First, the whole batteries are divided into bundles in accordance with the first step. 2P implies the number of batteries that are connected in parallel, that is, the number of batteries of a bundle. Therefore, in FIGS. 1A and 1B, the bundles are composed of two units of ten batteries 10, with the same terminals arranged. In this configuration, the total number of bundles is five. This is 5S, that is, the same as the number of bundles that are connected in series.

The bundles are arranged to be connected one another in series in accordance with the second step. FIG. 1A shows an example of a plurality of batteries 10 arranged in a 5S2p structure. The bundles are stacked on another. In this configuration, on one side of the arrangement, it can be seen that anodes 11 are arranged at the uppermost position, and electrodes of the bundles are alternately arranged in the column direction. As shown in FIG. 1B, the electrodes of the batteries are arranged opposite to the electrodes of the batteries shown in FIG. 1A, at the other side of the electrodes. That is, cathodes 12 are at the uppermost position of the other side and the electrodes of the bundles are alternately arranged in the column direction.

The connection relationship of the batteries shown in FIGS. 2A and 2B according to the third step is described hereafter. FIG. 2A is a perspective view showing that the batteries are connected via connection taps 21. FIG. 2B is a perspective view showing the other side of FIG. 2A.

First, it can be seen that the two batteries 10 are connected in each bundle. This is applied in the same way to other side shown in FIG. 2B. Next, the bundles are connected in series via the terminals 20. One embodiment uses specific conductors 25, such as wires, in order to reduce the distance between the terminals 20 for cost and space effectiveness.

Meanwhile, a coordinate system shown in FIGS. 3A and 3B is used below to simply explain the arrangement of the batteries. In the battery array, the coordinates of FIG. 3A are used when one of the two sides of the electrodes is directly seen. The coordinates of FIG. 3B are used when the battery array is projected from one side to the other side. The coordinates of the other side are the same as when the other side is directly seen, that is, when the coordinates of FIG. 3A are 180 degrees turned horizontally.

One embodiment is an NS3P type battery array. In this embodiment, one bundle includes three batteries connected in parallel and total N bundles are connected in series. N and M are natural numbers. Hereafter, for the purpose of convenience, an example of a 7S3P structure and a standardized rule for implementing an NS3P battery array will be described. However, other battery arrangements having N rows and three columns are also possible.

### Embodiment 1

In this embodiment, one bundle (3P) includes three battery cells connected in parallel. Total seven bundles are provided. The battery array according to this embodiment is arranged in total seven rows and three columns. In one embodiment, each battery has a cylindrical shape. Each battery may have a non-cylindrical shape.

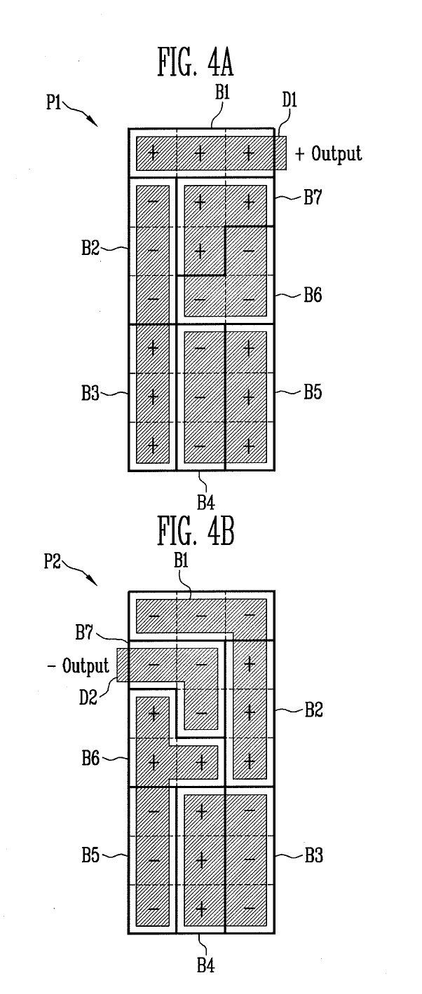

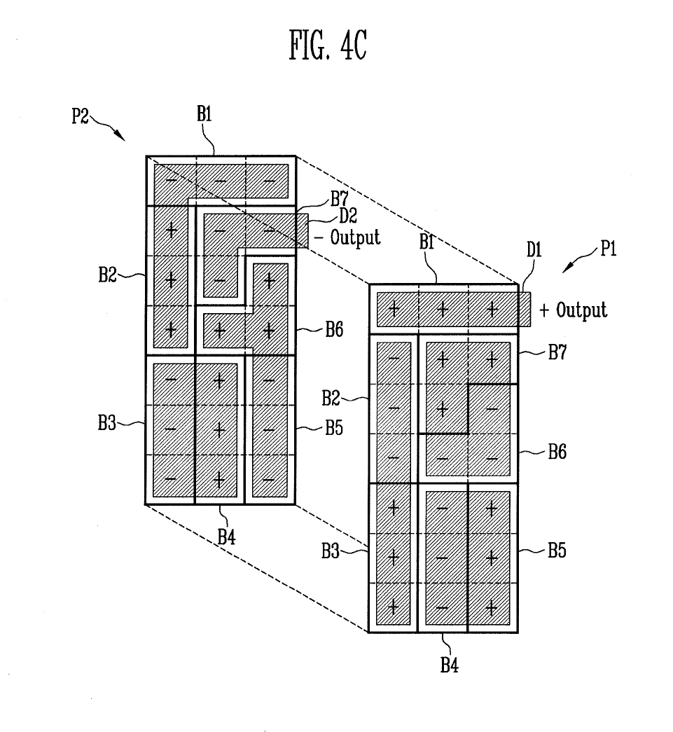

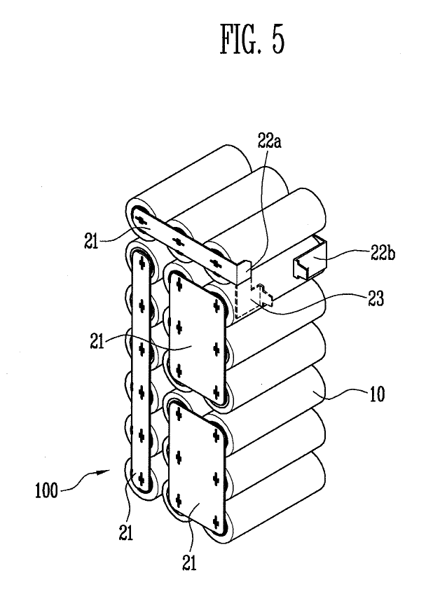

The arrangement of batteries according to this embodiment is described with reference to FIGS. 4A and 4C. FIG. 4A is a conceptual diagram showing one side of the electrodes of the 7S3P battery array. FIG. 4B is a conceptual diagram showing the other side of the electrodes of the battery array of FIG. 4A. FIG. 4C is a conceptual diagram of the battery array of FIG. 4A, projected from one side. As described above, when the other side P2 of FIG. 4C is 180 degrees horizontally turned, this is the same as the arrangement of FIG. 4B.

First, three batteries (3P) connected in parallel are classified in one bundle. In Embodiment 1, total seven bundles (7S) are provided.

Next, the bundles are arranged at one side P1, as shown in FIG. 4A, to connect seven bundles in series. First bundle B1 is disposed horizontally in the first row. Referring to FIGS. 3A and 4A, a first bundle [(1,1), (1,2), and (1,3)] is disposed in the first row such that the anodes (+ terminals) are seen from the side P1. Next, a second bundle B2 [(2,1), (3,1) and (4,1)] is disposed in the first column such that the cathodes (− terminals) are seen from the side P1 and a third bundle B3 [(5,1), (6,1) and (7,1)] is disposed in the first column such that the anodes (+ terminals) are seen from the side P1. Next, a fourth bundle B4 [(5,2), (6,2) and (7,2)] is disposed in the second column such that the cathodes (− terminals) are seen from the side P1 and a fifth bundle B5 [(5.3), (6.3) and (7.3)] is disposed in the third column such that the anodes (+ terminals) are seen from the side P1. Further, a sixth bundle B6 [(3,3), (4,3) and (4,2)] is disposed in the second and third columns such that the cathodes (− terminals) are seen from the side P1 and a seventh bundle B7 [(3,2), (2,2) and (2,3)] is disposed in the second and third columns such that the anodes (+ terminals) are seen from the side P1. In this arrangement, the bundles are disposed such that opposite polarities are shown on the other side P2, as shown in FIG. 4B. This can be clearly seen from the conceptual projection diagram of FIG. 4C.

The connection relationship of the batteries is described with reference to FIG. 4C. The connection taps are shown bold in FIGS. 4A-4C. First, three batteries of each bundle are connected. Next, the first bundle B1 to the seventh bundle B7 are sequentially connected in series. The first bundle B1 and the second bundle B2 are connected at the side P2, and the second bundle B2 and the third bundle B3 are connected at the side P1. Next, the third bundle B3 and the fourth bundle B4 are connected at the side P2. In one embodiment, the polarities of the first to seventh bundles are alternately arranged at each side of the battery array. In this embodiment, the bundles are connected to different polarities, such that the entire bundles are connected in series.

In one embodiment, as shown in FIG. 5, an anode output terminal D1 extends from the connection tap 22a in the first row and third column (1,3) on the side P1, and a cathode output terminal D2 extends from the connection tap 22b in the second row and first column (2,1) on the side P2. However, it should be noted that the coordinate system for the side P2 is turned left and right as shown in FIG. 4B.

The battery array 100a according to Embodiment 1 are shown in FIG. 5. In this embodiment, the distance between anode and cathode output terminals 22a, 22b is minimized compared to typical battery array. An extension tap 23 may be further provided such that both output terminals 22a and 22b are positioned on the outer circumference of the same battery 10. The extension tap 23 may extend from any one of both output terminals 22a and 22b to the outer circumference of the battery 10 where the outer output terminal is positioned. The connection tap 21 may be made of nickel or a nickel alloy.

The positions of the anode and the cathode may be switched to each other in Embodiment 1. Further, the same result can be achieved even though the configurations of FIGS. 4A and 4B are turned horizontally or vertically and to be symmetrically disposed.

### Embodiment 2

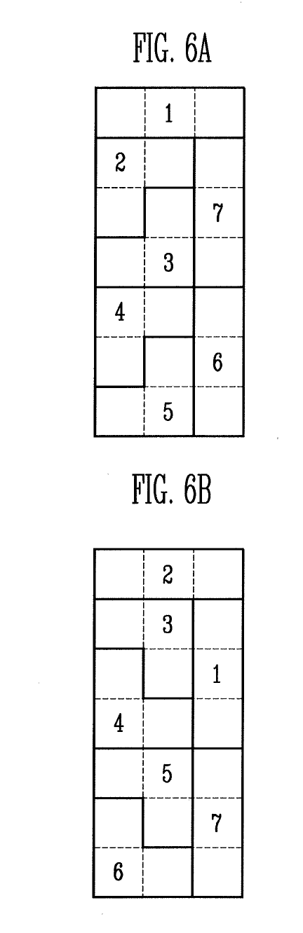

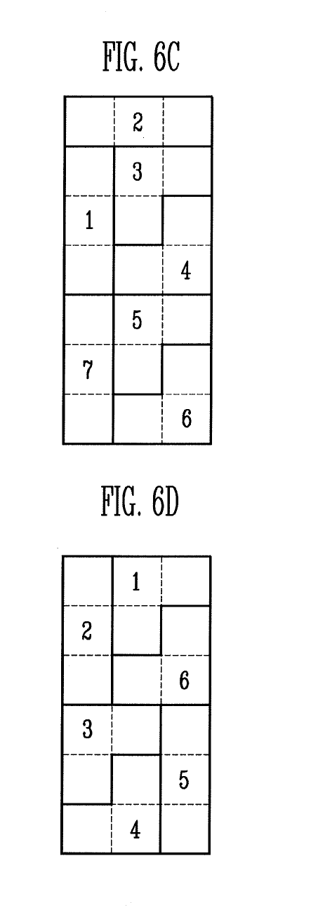

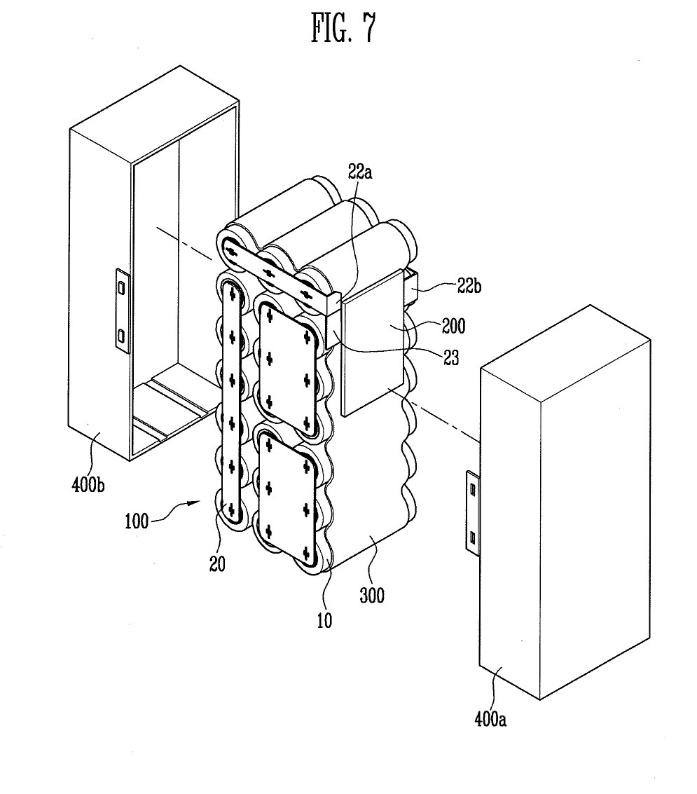

As described above, the series connection of the batteries can be achieved by a simple work, after the bundles are appropriately disposed. Hereafter, a standardized rule of implementing a 7S3P battery array to minimize the distance between electrode terminals is described, using the concept of a bundle. In one embodiment, this is achieved by disposing batteries such that the following several rules are all satisfied. Further, as described above, when the batteries are disposed at one side with the electrodes of the battery array, the arrangement at the other side is correspondingly determined. Therefore, the following rules are described on the basis of one side with electrodes as shown in FIGS. 6A to 6D.

In one embodiment, batteries are disposed so as to satisfy all of the following rules in order to implement an NS3P battery array. In the following rules, n is a natural number between 2 and N.

First rule: Dispose a first bundle to the N-th bundle such that at least one battery is positioned in the outermost column or row.

Second rule: Dispose the n-th bundle adjacent to the n−1-th bundle, in the outermost column or row, and dispose the first bundle adjacent to the N-th bundle, in the outermost column or row.

Third rule: Make the polarities of the n−1-th bundle and the n-th bundle different.

The first bundle may be disposed in any one of the battery array, as long as at least one battery is disposed in the outermost column or row, under the first rule. Each bundle may be disposed with the three batteries in a straight line or in an L-shape, as shown in FIG. 6A.

One closed curve is constructed when the first bundles to the N-th bundles are disposed in accordance with the second rule. That is, while the bundles are sequentially and continuously disposed, the bundles should not be disposed, with blanks in the battery array or with one bundle occupying the entire one row, except for the first row and the N-th row. For example, when one bundle is disposed across the first row to the third row of one column, the bundles are necessarily not continuous, that is, are necessarily disconnected, such that this arrangement of bundles runs counter this rule. Meanwhile, the bundles are sequentially disposed substantially clockwise or substantially counterclockwise with respect to the first bundle and the N-th bundle is finally disposed adjacent to the first bundle in the outermost column or row.

The third rule is given to connect the bundles in series, such that it may be natural.

Whether to implement a 7S3P battery array having a minimum distance between output terminals when the first to third rules described above are satisfied is described with reference to FIGS. 6A to 6D. FIGS. 6A to 6D are conceptual diagrams showing various embodiments in which batteries are disposed under the first to third rules described above. The battery arrays shown in FIGS. 6A to 6D are referred to as a first battery array to a fourth battery array, respectively, for the convenience of description.

Referring to the first battery array (see FIG. 6A), a first bundle is disposed horizontally in the first row. The first bundle has at least one battery in the first row, which is the outermost row, such that it satisfies the first rule. This is also applied in the same way to the other bundles. Meanwhile, the second bundle is adjacent to the first bundle at the first column corresponding to the outermost row or column, it satisfies the second rule. Further, the sixth bundle is adjacent to the fifth bundle at the seventh row, which is the outermost row, and the seventh bundle is adjacent to the third column of the first row which is the outermost row or column, such that they satisfy the second rule. The other bundles also satisfy the second rule. The third rule is to alternately dispose the electrodes and can be simply satisfied, such that detailed description is not provided.

The first bundle is positioned at (2,3), (3,3) and (4,3) in the second battery array (see FIG. 6B). The second bundle to the seventh bundles are sequentially disposed substantially counterclockwise with respect to the first bundle. The bundles satisfy the first to second rules. In the second array, an output terminal may be formed at (4,3) and (5,3) where the first bundle and the seventh bundle are adjacent to each other. However, since the number of entire bundles is an odd number, the first bundle and the seventh bundle have the same polarity on one side. Therefore, in this embodiment, one output terminal is formed at one side and the other side, respectively.

The first bundle to the seventh bundle are sequentially disposed substantially clockwise in the third battery array (see FIG. 6C). Since the bundles are disposed to satisfy the first rule and the second rule, it can be considered as being suitable as the 7S3P battery array.

The fourth battery array (see FIG. 6D) is an example when N is an even number, that is, 6. Since the fourth array satisfies the first rule and the second rule, it can be considered as having an appropriate arrangement for a 6S3P battery array. However, since the number of whole bundles is 6, the first bundle and the sixth bundle have different polarities at one side. Therefore, the output terminals may be formed simultaneously at any one of one side and the other side.

### Embodiment 3

Embodiment 3 relates to a battery pack having the battery array described above. A schematic structure of a battery pack having the battery array 100 described above is described with reference to FIG. 7. FIG. 7 is an exploded perspective view showing an embodiment of a battery pack having a 7S3P battery array.

Both output terminals 22a, 22b are connected to terminals (not shown) for connecting a protection circuit module (PCM) of a printed circuit board 200. In this configuration, since N is an odd number, as described above, the output terminals 22a, 22b are formed at different sides. An extension tap 23 may be further provided to reduce the distance between the terminals and the extension tap 23 and the other output terminal 22b are connected to a terminal of the printed circuit board 200.

A case is provided to accommodate and support batteries. In one embodiment, the case includes a holder case 300 and outer cases 400a, 400b. The holder case 300 supports the arranged battery array 100 and functions as a support where the printed circuit board 200 is fixed. The outer cases 400a, 400b protect the components therein against external shock. The outer cases 400a, 400b may have a connecting portion (not shown) that connects the printed circuit board 200 with an external circuit, if needed.

At least one of the disclosed embodiments provides a battery pack which minimizes the distance between both electrode terminals, even if a battery array is composed of a plurality of bundles each having a pair of multi-parallel batteries. Thus, a specific member or process is not needed to reduce the distance between terminals.

While the disclosed embodiments have been described in connection with the accompanying drawings, it is to be understood that the disclosed embodiments are not considered limiting. Thus, various modifications and equivalent arrangements are included within the spirit and scope of the appended claims, and-equivalents thereof.

What is claimed is:

1. A battery array, comprising:
a plurality of batteries arranged in N rows and three columns, wherein N is a natural number of 2 or more, wherein three batteries in each row are connected in parallel so as to make one bundle, wherein the batteries are sequentially arranged to form N bundles, and wherein the polarities of electrodes of the batteries, when seen from the same side of the battery array, are alternately arranged from a first bundle in the first row to an N-th bundle in the N-th row;
a plurality of connection taps configured to sequentially connect in series the first bundle to the N-th bundle; and
first and second polarity output terminals provided in the first bundle and the N-th bundle, respectively.

2. The battery array according to claim 1, wherein the arrangement of the batteries satisfies first, second and third rules, wherein the first rule prescribes that at least one battery of each of the first bundle to the N-th bundle is disposed in the outermost row or column,
wherein the second rule prescribes that i) the n-th bundle (n is a natural value between 2 and N) is disposed adjacent to the (n−1)-th bundle in the outermost row or column and ii) the first bundle and the N-th bundle are disposed adjacent to each other in the outermost row or column, and
wherein the third rule prescribes that the polarities of the n−1-th bundle and the n-th bundle are different.

3. The battery array according to claim 1, wherein the first and second polarity output terminals extend from the connection taps provided in the first bundle and N-th bundle, respectively.

4. The battery array according to claim 1, wherein the first and second polarity output terminals are provided on the same side of the battery array, where N is an even number.

5. The battery array according to claim 1, wherein the first polarity output terminal is formed in a first side of the battery array, and wherein the second polarity output terminal is formed in a second side of the battery array, which is opposing the first side, where N is an odd number.

6. The battery array according to claim 5, further comprising an extension tap that extends from the first polarity output terminal to the outer circumference of the battery on which the second polarity output terminal is formed.

7. The battery array according to claim 5, further comprising an extension tap that extends from the second polarity output terminal to the outer circumference of the battery on which the first polarity output terminal is formed.

8. The battery array according to claim 1, wherein the battery has a cylindrical shape.

9. The battery array according to claim 1, wherein the connection tap is made of nickel or a nickel alloy.

10. A battery pack having a battery array, the battery pack comprising:
a plurality of batteries arranged in N rows and three columns, wherein N is a natural number of 2 or more, wherein three batteries in each row are connected in parallel so as to make one bundle, wherein the batteries are sequentially arranged to form N bundles, and wherein the polarities of electrodes of the batteries, when seen from the same side of the battery array, are alternately arranged from a first bundle in the first row to an N-th bundle in the N-th row;
a plurality of connection taps configured to sequentially connect in series the first bundle to the N-th bundle;
first and second polarity output terminals provided in the first bundle and the N-th bundle, respectively;
a protection module to which the output terminals are connected; and
a case accommodating the batteries, the connection taps, the output terminals and the protection module.

11. The battery pack according to claim 10, wherein the arrangement of the batteries satisfies first, second and third rules, wherein the first rule prescribes that at least one battery of each of the first bundle to the N-th bundle is disposed in the outermost row or column,
wherein the second rule prescribes that i) the n-th bundle (n is a natural value between 2 and N) is disposed adjacent to the n−1-th bundle in the outermost row or column and ii) the first bundle and the N-th bundle are disposed adjacent to each other in the outermost row or column, and
wherein the third rule prescribes that the polarities of the (n−1)-th bundle and the n-th bundle are different.

12. The battery pack according to claim 10, wherein the first and second polarity output terminals extend from the connection taps provided in the first bundle and N-th bundle, respectively.

13. The battery pack according to claim 10, wherein first and second polarity output terminals are provided on the same side of the battery array, where N is an even number.

14. The battery pack according to claim 10, wherein the first polarity output terminal is formed in a first side of the battery array, and wherein the second polarity output terminal is formed in a second side of the battery array, which is opposing the first side, where N is an odd number.

15. The battery pack according to claim 10, further comprising an extension tap that extends from the first polarity output terminal to the outer circumference of the battery on which the second polarity output terminal is formed.

16. The battery pack according to claim 14, further comprising an extension tap that extends from the second polarity output terminal to the outer circumference of the battery on which the first polarity output terminal is formed.

17. The battery pack according to claim 10, wherein the battery has a cylindrical shape.

18. The battery pack according to claim 10, wherein the connection tap is made of nickel or a nickel alloy.

19. A method of making a battery array, the method comprising:
providing a plurality of batteries arranged in N rows and three columns, wherein N is a natural number of 2 or more, wherein three batteries in each row are connected in parallel so as to make one bundle, wherein the batteries are sequentially arranged to form N bundles, and wherein the polarities of electrodes of the batteries, when seen from the same side of the battery array, are alternately arranged from a first bundle in the first row to an N-th bundle in the N-th row;
arranging the first bundle to the N-th bundle such that at least one battery is positioned in the outermost column or row;
placing an n-th bundle adjacent to an (n−1)-th bundle in the outermost column or row, wherein n is a natural number between 2 and N;
disposing the first bundle adjacent to the N-th bundle in the outermost column or row; and.
arranging the polarities of the n−1-th bundle and the n-th bundle to be different.

20. The method according to claim 19, further comprising:
sequentially connecting in series the first bundle to the N-th bundle via a plurality of connection taps; and
providing first and second polarity output terminals in the first bundle and the N-th bundle, respectively.
